(19) United States
(12) Patent Application Publication
(10) Pub. No.: US 2003/0188477 A1
(43) Pub. Date: Oct. 9, 2003

(54) Environmentally friendly conditioning system particularly for a greenhouse

(76) Inventors: Dov Pasternak, Beer-Sheva (IL); Zvi Zamir, Kiryat Ono (IL); Eliyaho Korin, Beer-Sheva (IL)

Correspondence Address: MERCHANT & GOULD PC, P.O. BOX 2903, MINNEAPOLIS, MN, 55402-0903, US

(21) Appl. No.: 10/296,764

(22) PCT Filed: Jun. 14, 2001
(86) PCT No.: PCT/IL01/00546

(51) Int. Cl. A01G 9/00

(52) U.S. Cl. 47/17

(57) ABSTRACT

An environmentally friendly system (10) and corresponding method are provided for the conditioning of an indoor space (50), particularly of a greenhouse (60), in terms of the temperature, the humidity and sterility thereof. Air is forced into the indoor space (50) via a cloud of drops to form an air-water mixture, thereby conditioning the airstream as desired. The mixture then passes through a diffuser arrangement (30) to remove much of the water entrained by the airstream, and the resulting flow is provided to the indoor space (50). The degree of conditioning may be controlled by adjusting the delivery pressure and the form and density of water drops in the cloud, and the water drops optionally contain an evaporable biocide. Preferably, the system maintains a positive air pressure throughout the defined indoor space (50).

### FIELD OF THE INVENTION

The present invention relates to a system and associated method for conditioning an indoor space, in particular for the adiabatic cooling and/or warming thereof, as applied for example to greenhouses

### BACKGROUND OF THE INVENTION

High indoors air-temperature is a central problem for the greenhouse industry in many regions of the world. In recent years, with the introduction of insect proof, fine mesh, screens, which markedly reduce greenhouse air circulation, this problem has become even more acute.

In Mediterranean-type climates, greenhouse air temperatures may reach levels as high as 45-50° C. Excess heat reduces yields and decreases product quality.

The effective and efficient utilization of greenhouses for year-round crop production depends on the ability to increase or reduce air temperatures to near optimal levels for crop production.

There are a few economically feasible means to reduce ambient greenhouse temperatures. The main ones are: natural or forced ventilation; reduction of radiation (shading); and a combination of evaporative cooling with natural or forced ventilation.

Each of the above methods has its specific advantages and disadvantages. Natural or forced ventilation is effective only where outside air temperature is lower then the optimal temperature levels for production of crop. Shading makes it very complicated to optimize to the desired light intensity.

A combination of evaporative cooling with natural or forced ventilation is by far the most effective means for cooling, particularly in regions where air relative humidity is lower than 50%, since it may result in a significant reduction of greenhouse air-temperature as compared to the outdoors air temperature.

Presently, there are two major commercial approaches for adiabatic (evaporative) cooling of greenhouses, commonly known as the “mist” and “pad and fan” cooling systems.

In the “mist” cooling system, the mist is normally produced either by forcing pressurized water through small orifice nozzles or by passing compressed air over a stream of water: the mist evaporates, thus cooling the air. The humidified air is sucked out of the greenhouse by fans. The main disadvantages of this system include the potential of blockage of the spray nozzles by salts and dirt, the high cost of pressurized air and the need for high quality water in order to avoid deposition of salt on the plant leaf surface, and blockage of the spray nozzles which may occur when water of low quality is used.

The “pad and fan” system typically comprises a specially designed absorption pad with a large surface area, positioned over an opening in one wall of the greenhouse, and fans are positioned on the opposite wall. The pad is wetted with a stream of water and the outdoors dry air, which is sucked through the pad and into the greenhouse, evaporates the water resulting in adiabatic cooling of the air. The main disadvantages of this system include:

1) In dry dusty regions with relatively “hard” water, dirt and insoluble salts block the pad. If the pads are not treated to remove the blockages, they must be changed regularly, typically every three years.

2) Poor distribution (vertically and horizontally) of the cooled air throughout the greenhouse.

3) Creation of negative air pressure in the greenhouse, which results in insects, spores and bacteria being sucked in through holes and openings in the greenhouse envelope.

In view of the above mentioned shortcomings there is a need for an improved, and in particular an environmentally-friendly conditioning system and method therefor, in particular to provide cooling that will be free of the disadvantages listed above.

It is another aim of the present invention to provide such a system that is relatively economical to install and to operate.

Thus, it is an object of the present invention to provide an air conditioning system that comprises a “wall of drops” compartment where heat and mass exchange takes place. It is a further object of the present invention that such a system be an environmentally-friendly system. It is a further object of the present invention to establish a process and system for conditioning the temperature of a defined indoor space optionally provides a positive air pressure within said indoor space. It is yet a further object of the present invention to provide a system for conditioning the temperature, and at the same time sterilizing, a defined indoor space, using an evaporable biocide.

### SUMMARY OF THE INVENTION

The present invention provides a process and an environmentally friendly system for conditioning the temperature, the humidity and sterility of a defined indoor space—as follows: forming a mixture of air and controllable size and number of water drops having a predetermined temperature; wherein said water drops optionally contain an evaporable biocide;

separating the air from the water droplets using a falling gradient of velocity that allows the transfer of the conditioned air and the evaporated biocide into said defined indoor space and prevents the transfer of water; collecting the non-evaporated water for recycling; optionally, continuously maintaining a positive air pressure throughout the defined indoor space of interest and continuously removing the air through an outlet having a controllable size of opening, located on a faraway wall or ceiling.

Thus, the present invention provides a method for conditioning an indoor space, comprising the steps of:

(a) providing a plurality of water droplets in a control volume;

(b) inducing an air flow within said control volume such as to enable heat exchange between the said air flow and the said droplets;

(c) increasing the flow area available to the air-water mixture provided in step (b) to separate a proportion of the water from the mixture;

(d) removing the proportion of separated water from the air-water mixture;

(e) directing the resulting air-water mixture remaining in (d) to the indoor space.

The method of the present invention relates to conditioning an indoor space, wherein the degree of conditioning may be controlled by controlling the size of the said droplets in step (a) and/or by controlling gauge pressure of the water providing said droplets in step (a).

The method of present invention may optionally further comprise the step (f) of collecting the separated water in step (e) and recirculating the water for use in step (a), and/or adding an additive, such as a sterilizer, to the said droplets in step (a).

Typically, the heat exchange between the air flow and the droplets in step (b) comprises providing the latent heat of evaporation to at least some of said droplets by said air flow.

Preferably, the air flow is induced in step (b) in a manner such as to increase the ambient pressure within said indoor space.

The method optionally further comprises the step of filtering the air-water mixture remaining from step (d) prior to step (e). The filtering step substantially prevents entry therethrough of foreign matter including insects.

Typically, the flow area in step (c) is increased by between about 300% and 800% and preferably by about 600%.

The method of present invention relates in particular, but not exclusively, to conditioning an indoor space of a greenhouse.

The present invention also relates to a system for conditioning an indoor space, comprising:

a ducting having an open inlet end and an outlet end;

water provision system adapted to provide droplets of water within said ducting;

air circulation means adapted to induce an airflow from outside said ducting through said ducting via said inlet end;

diffusion arrangement at said outlet end having an outlet area greater than the inlet area of thereof.

In the preferred embodiment, said ducting is in the form of a U, having an upstream arm and a downstream arm, wherein said droplets of water are provided by said water provision system at said upstream arm. Optionally, the upstream arm and said downstream arm are separated by a common wall, and the upstream arm and said downstream arm are substantially vertical. Further optionally, the system also comprises a gutter arrangement at a bottom end of said U.

The water provision system preferably comprises at least one nozzle having a nozzle outlet located in said upstream arm of said duct, said at least one nozzle being operatively connected to a suitable water source, typically a suitable reservoir, which is preferably in open communication with a gutter arrangement.

Optionally, the diffuser arrangement comprises a screen at the downstream end thereof, and the screen may be particularly adapted to prevent passage therethrough of foreign matter including insects.

The air flow or air circulation means comprises at least one fan located in greenhouse envelope that defines the indoor space, such as to provide a negative air pressure in said indoor space to induce suction of air through said duct. In the preferred embodiment, however, the duct inlet is open to outside of said indoor space and said air circulation means comprises at least one fan located at said duct inlet such as to provide a positive air pressure in said duct and said space.

The system of the present invention is adapted for conditioning the indoor space by reducing the temperature of the air passing therethrough.

Alternatively or additionally, the duct inlet may be in open communication with said indoor space and said air circulation means comprises at least one fan located at said duct inlet such as to provide a positive air pressure in said duct to induce suction of air through said duct. Furthermore, the water provision system may provide water having a temperature substantially higher or lower than the ambient temperature within said indoor space, wherein said system respectively increases or decreases the temperature of the air passing therethrough.

The system may further optionally comprise means for adding a suitable additive, such as a suitable disinfectant to the water provided by said water provision system.

The diffuser arrangement comprises an outlet to inlet area ratio greater than unity, preferably between about 3:1 to about 8:1 and more preferably about 6:1.

In the preferred embodiment, the duct comprises walls that are substantially non-transparent.

### BRIEF DESCRIPTION OF THE FIGURES

FIG. 1 schematically illustrates the main elements of a preferred embodiment of the present invention installed with respect to a greenhouse. FIGS. 2(a) and 2(b) show the results obtained respectively for the system of the present invention and for the “pad and fan” system, as temperature (T) Vs height (H) profiles obtained at the centre of the greenhouse.

FIGS. 3(a) and 3(b) show the effect of water pressure on air temperature and relative humidity at 1 m height in the greenhouse obtained with the system of the present invention.

### DESCRIPTION

The present invention is defined by the claims, the contents of which are to be read as included within the disclosure of the specification, and will now be described by way of example with reference to the accompanying Figures.

All examples are given by way of clarification, and are not to be construed as being comprehensive, or in any other way limiting.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The term “downstream” is herein taken to refer to the general direction of air flow within the system of the invention, while the term “upstream” refers to the opposite direction thereto. Thus, the airflow in the system flows from an upstream part to a downstream part thereof.

The present invention relates to a system and corresponding method for conditioning an indoor space, in particular of greenhouses. The term “conditioning” refers to the treatment of air in the indoor space such as to provide a desired change in at least the temperature thereof.

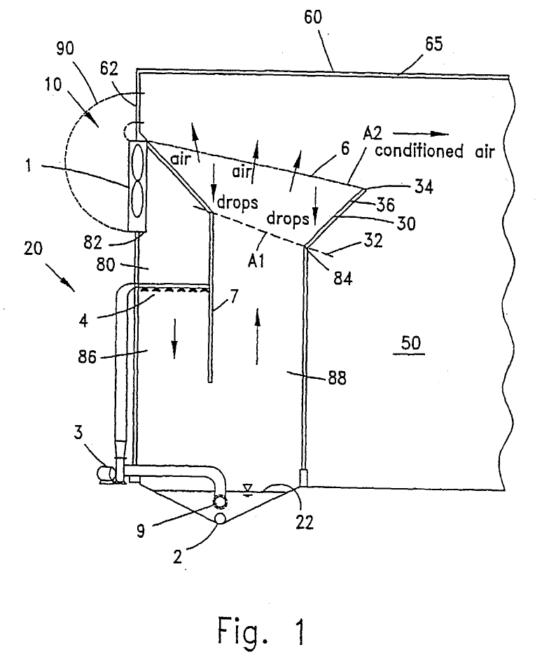

A preferred embodiment of the system according to the present invention is illustrated in FIG. 1. This embodiment is particularly adapted for installation in a greenhouse, but may be adapted for any other suitable indoor space in a similar manner to that described herein, mutatis mutandis.

Referring, then, to FIG. 1, the system of the present invention, generally designated by the numeral (10), comprises an air circulation means (1), a water provision system (20) and a diffuser arrangement (30) having an outlet in communication with the indoor space (50) of a greenhouse (60). The system (10) of the present invention also comprises suitable ducting (80) having an upstream inlet (82), typically open to the outside environment, and a downstream outlet (84) in communication with the said diffuser arrangement (30).

In the preferred embodiment, the air circulation means (1) comprises one or more suitable fans capable of forcing air into the indoor space (50) via the system (10). Preferably, the air circulation means (1) comprises a fan capable of supplying about 50 g of air per 1 square meter of soil area in the greenhouse per second, preferably at pressures of about 50 Pascal. Also in the preferred embodiment, the fan is provided at the duct inlet (82), upstream of the water provision system (20) and the diffuser arrangement (30). In other embodiments, the air circulation means may comprise, one or more fans situated in the walls or general envelope (65) that define the indoor space (50) of the greenhouse (60) and adapted for exhausting air from the greenhouse (60), thereby forcing air to be drawn into the greenhouse (60) via system (10). In the latter case, when the fans are downstream of the system and are used to suck in air therethrough, a negative air pressure is created within the indoor space (50). In this case, it is particularly important to minimise leaks within the greenhouse (60) itself, to reduce the risk of foreign matter, such as insects, bacteria and so on, entering the greenhouse (60), and also not to impair the efficiency of the system (10).

The water provision system (20) comprises at least one battery of nozzles (4) operatively connected to a suitable water supply, typically a reservoir (2) and water is drawn therefrom to the nozzles (4) via a suitable pump (3). The nozzles (4) are located within the ducting (80) and are particularly adapted for providing a cloud or curtain of droplets in the path of the incoming air (from outside the greenhouse (60)), upstream of the diffuser arrangement (30). This curtain or cloud of droplets is also referred to herein as a “wall of drops”. Water is ejected from the nozzles (4) typically at about 60 Kpascal, the droplets formed being preferably of about 0.6 mm MMD (mass median diameter), with less than 0.1% of droplets (by volume) having a diameter which is smaller than 0.1 mm MMD. The water from the reservoir (2) is typically filtered via filter (9), and advantageously comprises low quality water such as, for example, sea water, used water, or the greenhouse's own re-circulated water. Of course, fresh water may also be used. The pump (3) is typically rated for supplying up to about 50 g water per 1 square meter of greenhouse soil area per second, at, preferably, up to about 100 Kpascal. Optionally, pump (3) may be replaced with a plurality of pumps, in which case all the pumps may be operated to provide water at the same pressure, or alternatively, each individual pump may be calibrated to provide a different amount of water.

The ducting (80) is preferably U-shaped, having the inlet end (82) at the upper end of the upstream arm (86) of the “U”, and the outlet end (84) at the upper end of the downstream arm (88) thereof. The arms of the “U” are conveniently separated by a substantially vertical separating wall (7). The diffuser arrangement (30) has an inlet end (32) of cross-sectional area A1, in open and typically exclusive communication with the outlet end (84) of the ducting (80), and comprises an outlet end (34) of enlarged cross-sectional area A2. Typically, the diffuser arrangement (30) has gently sloping side walls (36), but may comprise instead sharply sloping walls where necessary. The diffuser arrangement (30), as the ducting (80), may comprise a rectangular, polygonal, circular or any other suitable cross-sectional profile. The diffuser arrangement (30) has a ratio A2:A1 greater than 1, and preferably about 3 to about 6 or 8, or more. Preferably, at least the upstream arm (86), and more preferably the ducting (80) and the diffuser arrangement (30), are made from non-transparent materials to prevent formation of algae.

Preferably, a suitable screen (6), say 50 mesh for example, is provided at the diffuser outlet (34), particularly useful for preventing ingress of foreign matter such as, for example, insects and other pests, and thus the type of screen (6) may be chosen according to local requirements. In particular, the screen (6) may also assist in reducing the amount of water that is entrained with air into the greenhouse (60) via the system (10), as described further hereinbelow.

Operation of the system (10) is as follows. The air flow or air circulation means (1), typically one or more fans, draws ambient air from outside the greenhouse (60) into the upstream arm (86) of ducting (80) via inlet (82). A curtain or cloud of droplets (“wall of drops”) is provided by the water provision system (20), in particular the nozzles (4) thereof, in the upstream arm (86) of the ducting (80). As the airstream through the upstream arm (86) progresses downstream therethrough under positive pressure provided by the fan of the air circulation means (1), the airstream encounters the “wall of drops”, and any dust carried by the air is absorbed by the water droplets. More importantly, heat exchange takes place between the airstream and the water droplets, wherein the air cools by providing the latent heat of evaporation required by the water droplets to at least partially evaporate within the airstream. Concurrently, there is also an accompanying mass exchange, as some of the water droplets vaporise to the gaseous (steam) phase and form part of an air-water mixture. The degree of conditioning may be controlled by adjusting the water delivery pressure provided by the pump (3), as well as by controlling the form, i.e., the MMD of the droplets, and density of water drops in the cloud, i.e., the amount of drops per unit volume of air passing through the duct (80). The MMD of the drops may be adjusted by providing suitable nozzle exit openings, for example, and the drop density may be adjusted by increasing the quantity of the nozzles and the volume flow of the water provided from reservoir (2) (with or without adjusting the delivery pressure of the water).

As the air-water mixture progresses around the bend of the “U”, some of the larger droplets, as well as much of the water provided by the nozzles (4), is recovered via a gutter system (22), and the water preferably returned to the reservoir (2) for recycling and recirculating in the water provision system (20). As the air-water mixture proceeds downstream in an upward direction along the downstream arm (88), some of the remaining droplets slow down and fall by gravity to the gutter (22). As the air-water mixture progresses through the diffuser arrangement (30), the increase in cross-sectional flow area provided thereby reduces the air velocity of the air- and water droplets mixture. Furthermore, the dramatic reduction of the velocity of the air-water mixture brought about by the diffuser arrangement (30) also results in more water droplets falling directly to the gutter (22), or at least settling on the walls of the downstream arm (88), eventually to be collected by gutter (22) and the water reservoir (2) for recycling. Finally, the airstream provided by the system (10) has a reduced temperature as compared to the outside ambient air, and at the same time has a substantially controlled humidity compared with the “mist” and “pad and fan” cooling systems of the art.

The large outlet area (A2) of the diffuser outlet (34) has the advantage of providing a relatively slow-moving air stream having a large flow area into the greenhouse (60), which facilitates the uniform diffusion of this air within the indoor space (50), and advantageously enhances mixing with the air already therein.

Thus, the diffuser arrangement (30) acts as a water droplets “trap”, substantially preventing influx of water droplets into the greenhouse (60). After mixing with the air in the indoor space (50), the overall indoor temperature (T_{IN}) is correspondingly reduced, and the mixed air is exhausted through a greenhouse outlet (not shown), which is covered with an insect-proof net, typically located in an opposite or distant wall or ceiling in envelope (65) of the greenhouse (60) with respect to the location of the system (10). This greenhouse outlet has an opening which is preferably variable and controllable, typically by means of a curtain or shutter, for example, and which is preferably also covered with an insect-proof net. The rate of air flow provided by the system (10) through the greenhouse, as well as the magnitude of the positive air pressure provided to the greenhouse (60) are determined by both the size of the greenhouse outlet opening and the number of fans in operation comprised in the air circulation means (1). Furthermore, the relative humidity of the air flowing from the system (10) throughout the greenhouse (60), may be regulated by the number of nozzles (4) in operation and the pressure of the water sprayed thereby.

The system (10) has been described as providing cooling of the indoor space (50). Alternatively, the system (10) of the present invention may be used for conditioning the indoor space (50) such as to increase the temperature thereof, as follows. A suitable heater (not shown) is provided for heating the water provided by nozzles (4). Alternatively, warm water from a suitable source is provided to the nozzles (4). Further, the air circulation means (1) is configured such as to recirculate air from the greenhouse (60) and through the water curtain provided by the nozzles (4). Thus, the preferred embodiment illustrated in FIG. 1 may be adapted for heating the greenhouse (60) by providing suitable air ducting (not shown) from the greenhouse outlet to the duct inlet end (82). Thus, the greenhouse (60) is kept closed and internal air is supplied to the air circulation means (1) and circulated over the warm droplets. Heat is released from the water to warm the greenhouse air. This system (10) creates a water vapor saturated atmosphere, which may induce for development of plant diseases. On the other hand, the heating process can also sterilize the air since the air is circulated through a wall of drops containing evaporable sterilizing agents.

Thus, the present invention also provides a method for conditioning an indoor space, comprising the steps of:

(a) providing a plurality of water droplets in a control volume;

(b) inducing an air flow within said control volume such as to enable heat exchange between the said air flow and the said droplets;

(c) increasing the flow area available to the air-water mixture provided in step (b) to separate a proportion of the water from the mixture;

(d) removing the proportion of separated water from the air-water mixture;

(e) directing the resulting air-water mixture remaining in (d) to the indoor space.

Step (a) may be provided by means of the water provision system (20), as herein described, the control volume being provided by ducting (80), in particular the upstream arm (86) thereof. Step (b) may be provided by the air circulation means (1), as herein described. Step (c) may be provided by the diffuser arrangement (30), as herein described. Step (d) may be provided by the diffuser arrangement (30), the downstream arm (88) and gutter arrangement (22), as herein described. Step (e) is provided by the diffuser arrangement (30), in conjunction with other elements of the system (10), in particular the air circulation means (1).

As will be demonstrated in the examples below, the degree of conditioning may be controlled by controlling the size of the said droplets in step (a) and/or by controlling gauge pressure of the water providing said droplets in step (a).

The method of present invention may optionally further comprise the step (f) of collecting the separated water in step (e), typically by means of gutter arrangement (22), and recirculating the water for use in step (a), and/or the step of adding an additive, such as a sterilizer, to the said droplets in step (a).

Typically, the heat exchange between the air flow and the droplets in step (b) comprises providing the latent heat of evaporation to at least some of said droplets by said air flow.

In the preferred embodiment, the air flow is induced in step (b) in a manner such as to increase the ambient pressure within said indoor space. In other embodiments, the air flow may be induced such as to provide a negative air pressure in the indoor space, as described hereinbefore.

The method optionally further comprises the step of filtering the air-water mixture remaining from step (d) prior to step (e), typically by providing the screen (6). The filtering step substantially prevents entry therethrough of foreign matter including insects and dust carrying spores and bacteria.

Typically, the flow area in step (c) is increased by between about 300% and 800% and preferably by about 600%, and this may be achieved using a suitable design for diffuser arrangement (30).

The method of present invention relates in particular, but not exclusively, to conditioning an indoor space of a greenhouse.

In addition to providing suitable conditioning of the indoor space (50), the conditioning system (10) and method of the present invention have a number of other advantages as compared to the commonly known “mist” and “pad and fan” systems of the art:

1) The system of the invention is configured to meet strict environmentally friendly requirements. For example, there is no need to use pesticides for protecting the plants. In addition, the combination of adiabatic cooling, indoor positive air pressure and water and air sterilization is unique, wherein used water may be reused in the system, and then recycled therein.

2). The system (10) and method may provide a positive air pressure in the greenhouse (60). This positive air pressure prevents the penetration of small insects, fungi spores, bacteria and other foreign material into the greenhouse (60). In contrast, other conventional systems, such as, for example, the commercial pad and fan systems operate under conditions of air suction and create negative indoors air pressure to suck in air from outside via the pad, and the negative air pressure thus produced actively pulls insects, spores of phyto-pathogenic fungi and bacteria into the greenhouse.

3) Optionally, an evaporable sterilizing agent (such as for example, hypochlorite, or any other substance that releases Cl₂ in an aqueous solution) may be added to the water in the reservoir (2) for sterilising the incoming air.

4). Most aphids, and insects larger than aphids, are typically washed away by the water droplets initially produced by the nozzles in the duct (80). Aphids and insects larger than aphids, that nonetheless escape this or that would otherwise enter the greenhouse when the pumps are not in operation, are prevented from doing so by the mesh screen (6) at the outlet (34) of the diffuser arrangement (30).

5) Optionally, the system (10) and method may insure the maintenance of a positive, sterilized air pressure, 24 hours a day, by operating at least one fan of the air circulation means (1) and one pump (3), such as maintain positive air pressure in the greenhouse (60) as well as air sterilisation, even when cooling (or heating) is not needed (for example, during the night).

6). Any dirt in the, incoming air is precipitated and accumulated in the bottom of the water reservoir (2). This dirt, in the form of mud, may be periodically. pumped out and discharged.

### EXAMPLES

### Example 1

A Comparison Between the “Wall of Drops” System of the Present Invention and a “Pad and Fan” System

As mentioned before the “pad and fan” system is today the dominant commercial system on the market. The performance of the system of the present invention was therefore compared with that of the “pad and fan” system—as follows:

A small 16×13 meters (6 meters high, 200 soil sq. m. and 500 cover sq. m.) greenhouse was used to compare the performance of the “wall of drops” with that of the “pad and fan”. Both systems were installed in the same greenhouse and the obtained data was compared. In both systems the air was sucked in through the greenhouse and a negative pressure was created within the greenhouse.

The “wall of drops” system, according to the present invention, without a fan, was set on the northern wall and a 50″, 1.5 Kw fan was installed on the southern wall. The “wet pad” was installed on the western wall and another 50″, 1.5 Kw fan was installed on the eastern wall. Air temperatures were measured with aspirated copper-constantan thermocouples attached to a multichannel data logger. Relative air humidity was measured with a standard aspirated Astman hygrometer. Air temperatures were measured in the center of the greenhouse at four heights (50, 100, 150 and 300 cm).

Measurements were carried out in the middle of the day (12:30-13:30 hours) in a typical Beer-Sheva late summer day (beginning of September 1999). First the “wall of drops” provided by the present invention was operated for 30 minutes. Then, the “pad and fan” system was operated for an additional 30 minutes. This was done in a manner such as to enable the water temperature in the reservoirs of each system to balance with the outside air temperature and humidity.

The outside solar radiation ranged between 860-880 watts/m², and the outside air temperature T_{AMB} ranged from 34.4° to 34.7° C. during the tests.

The results obtained are shown in FIGS. 2(a) and 2(b) respectively for the system of the present invention and for the “pad and fan” system, as temperature (T) vs height (H) profile. In both systems indoor air temperature at the height of 1 meter was around 28° C. However at other heights there were marked differences in temperatures. Air temperatures in the “pad and fan” system ranged from 25.5° C. at a height of 50 cm to about 31° C. at a height of 300 cm. In the system of the present invention, temperatures ranged from 27.8° C. at 50 cm to 29.2° C. at 300 cm.

The results indicate that in the system of the present invention there is a much better air mixing than in “pad and fan” system. The air circulation in the system of the present invention also provides a more uniform vertical temperature gradient which is an important advantage when trellised tall crops (2-2.5 meters) are grown.

A similar experiment that was done under conditions of positive air pressure, i.e., using a system similar to the preferred embodiment of the invention, reveals a reduction in temperature of the same greenhouse from 35.2° C. to 25.4° C.

### Example 2

Effect of Water Pressure on the Drop Size of “Wall of Drops” System and on Air Temperature and Relative Humidity.

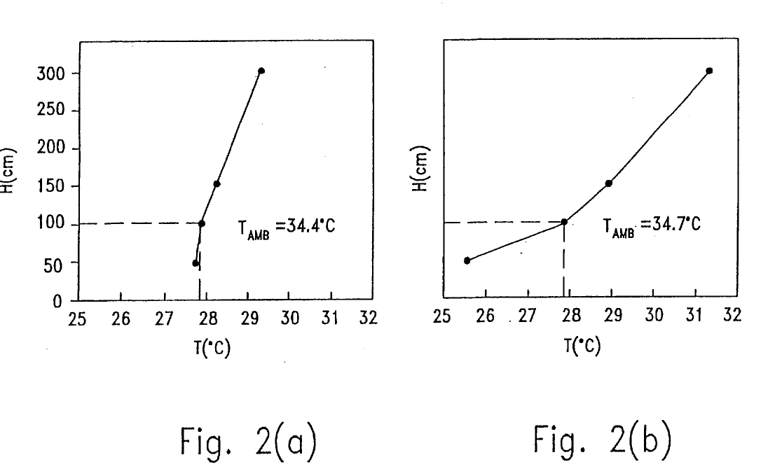

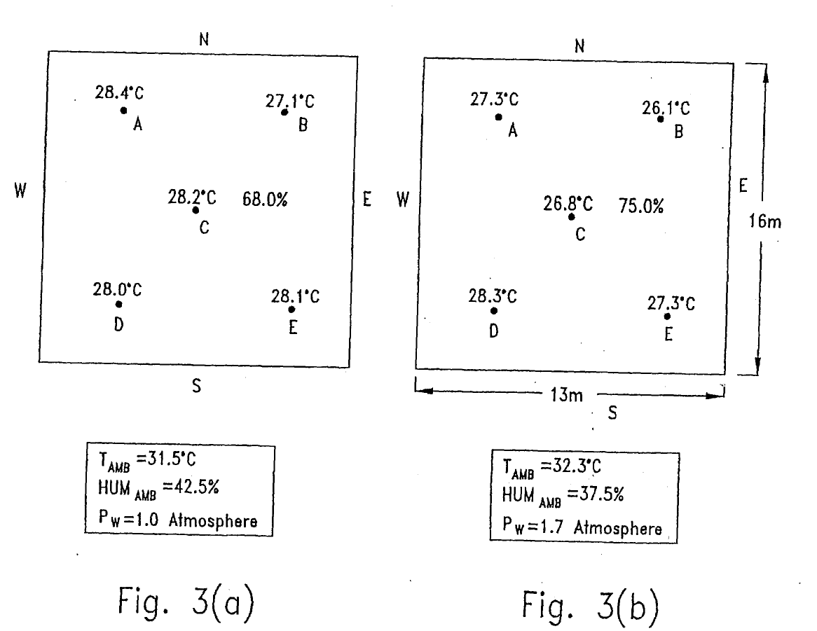

As in example 1 above, a “wall of drops” system, according to the present invention, without a fan, was set on the northern wall (N) and a 50″, 1.5 Kw fan was installed on the southern wall (S). Air temperature (T) at a height 100 cm was measured in the middle of the day at five locations in the greenhouse, marked A, B, C, D and E in FIGS. 3(a) and 3(b) during the operation of the system of the present invention. Relative humidity was measured manually with an aspirated Astman hygrometer.

Temperatures and relative humidities were then measured at these five locations under two conditions:

(a) when the gauge water pressure P_{W} in the spray nozzles was 1.0 atmospheres; and

(b) when the gauge water pressure P_{W} was 1.7 atmospheres.

In the first case (a), the size of the drops was greater and the number of drops was smaller compared to drop size and number thereof in the second case (b).

The results obtained are shown in FIGS. 3(a) and 3(b) respectively for cases (a) and (b) as temperature readings at the five locations and a humidity reading at the centre location. The results indicate that when the water drop size is smaller and their number is larger (1.0 atm) the heat transfer is higher as expressed by a lower mean air temperatures and higher relative humidity. Furthermore, in case (b), when pressure of 1.7 atmospheres was applied, evaporative cooling was very effective as compared with case (a) as evidenced by the increase of air relative humidity (HUM) from 37.5% (outdoors) to 75% in the center of the greenhouse. The outside air temperature T_{AMB} ranged from 34.4° to 34.7° C. during the tests.

It was found that in the 500 sq. m. covered (200 sq. m. soil) greenhouse, equipped with the system of the present invention with a standard 1.5 Kw fan and a 1.5 Kw pump, in a typical Beer-Sheva summer day, the mean indoors temperature was reduced by about 6° C. below outdoors temperature. Furthermore, the temperature of the air, at a height of up to 200 cm, traveling from the “wall of drops” towards the opposite greenhouse wall, increases by 1° C. over the first 14 meters thereof.

### Example 3

A number of leafy vegetables (lettuce, green onion, celery, radiccio, cauliflower, broccoli) were grown during a four months period (February-June, 2000) in a soil-free culture system inside a greenhouse installed with a system according to the present invention, using Cl₂ as biocide.

(i) Mean indoors air temperatures were normally 5.5°-6.5° C. below outdoors air temperatures. In a hot (38° C.) and dry (25% humidity) day indoors temperatures reached 29° C.

(ii) During this whole period no pests or disease were detected on the plants. Green onions (which are highly susceptible to trips attack were produced without spraying and were sent after two months of growth to a qualified entomological laboratory for analysis and no trips were found.

(iii) The cost for maintaining a system according to the invention is significantly lower compared with conventional “pad and fan” systems. The main reason for this difference appears to be in the use of local “hard” water that causes deposition of calcium carbonate in the pad, resulted in gradual clogging of the pad which becomes ineffective after three years of operation. Such a problem is not encountered in the system of the present invention.

While in the foregoing description describes in detail only a few specific embodiments of the invention, it will be understood by those skilled in the art that the invention is not limited thereto and that other variations in form and details may be possible without departing from the scope and spirit of the invention herein disclosed.

1. A system for conditioning an indoor space, comprising:
a ducting having an open inlet end and an outlet end;
water provision system adapted to provide droplets of water within said ducting;
air circulation means adapted to induce an airflow from outside said ducting through said ducting via said inlet end;
diffusion arrangement at said outlet end having an outlet area greater than the inlet area of thereof.

2. A system for conditioning an indoor space as claimed in claim 1, wherein said ducting is in the form of a U, having an upstream arm and a downstream arm wherein said droplets of water are provided by said water provision system at said upstream arm.

3. A system for conditioning an indoor space as claimed in claim 2, wherein said upstream arm and said downstream arm are separated by a common wall.

4. A system for conditioning an indoor space as claimed in claim 2, wherein said upstream arm and said downstream arm are substantially vertical.

5. A system for conditioning an indoor space as claimed in claim 2, further comprising a gutter arrangement at a bottom end of said U.

6. A system for conditioning an indoor space as claimed in claim 5, wherein said water provision system comprises at least one nozzle having a nozzle outlet located in said upstream arm of said duct, said at least one nozzle being operatively connected to a suitable water source.

7. A system for conditioning an indoor space as claimed in claim 6, wherein said water source comprises a suitable reservoir.

8. A system for conditioning an indoor space as claimed in claim 7, wherein said reservoir is in open communication with said gutter arrangement.

9. A system for conditioning an indoor space as claimed in claim 1, wherein said diffuser arrangement comprises a screen at the downstream end thereof.

10. A system for conditioning an indoor space as claimed in claim 9, wherein said screen is adapted to prevent passage therethrough of foreign matter including insects, spores and bacteria.

11. A system for conditioning an indoor space as claimed in claim 1, wherein said duct inlet is open to outside of said indoor space and said air circulation means comprises at least one fan located in said indoor space such as to provide a negative air pressure in said indoor space to induce suction of air through said duct.

12. A system for conditioning an indoor space as claimed in claim 1, wherein said duct inlet is open to outside of said indoor space and said air circulation means comprises at least one fan located at said duct inlet such as to provide a positive air pressure in said duct to induce suction of air through said duct.

13. A system for conditioning an indoor space as claimed in claim 1, wherein said system reduces the temperature of the air passing therethrough.

14. A system for conditioning an indoor space as claimed in claim 1, wherein said duct inlet is in open communication with said indoor space and said air circulation means comprises at least one fan located at said duct inlet such as to provide a positive air pressure in said duct to induce suction of air through said duct.

15. A system for conditioning an indoor space as claimed in claim 14, wherein said water provision system provides water having a temperature substantially higher or lower than the ambient temperature within said indoor space, and wherein said system increases or decreases, respectively, the temperature of the air passing therethrough.

16. A system for conditioning an indoor space as claimed in claim 1, further comprising means for adding a suitable additive to the water provided by said water provision system.

17. A system for conditioning an indoor space as claimed in claim 16, wherein said additive comprises a suitable disinfectant.

18. A system for conditioning an indoor space as claimed in any one of claims 1 to 17, wherein said diffuser arrangement comprises an outlet to inlet area ratio greater than unity.

19. A system for conditioning an indoor space as claimed in claim 18, wherein said area ratio is between about 3:1 to about 8:1 and preferably about 6:1.

20. A system as claimed in any one of claims 1 to 17, wherein said duct comprises walls that are substantially non-transparent.

21. A method for conditioning an indoor space, comprising the steps of:
(a) providing a plurality of water droplets in a control volume;
(b) inducing an air flow within said control volume such as to enable heat exchange between the said air flow and the said droplets;
(c) increasing the flow area available to the air-water droplets mixture provided in step (b) to separate a proportion of the water from the mixture;
(d) removing the proportion of separated water droplets from the air-water mixture;
(e) directing the resulting air-water vapor mixture remaining in (d) to the indoor space.

22. A method for conditioning an indoor space as claimed in claim 21, wherein the degree of conditioning may be controlled by controlling the size of the said droplets in step (a).

23. A method for conditioning an indoor space as claimed in claim 21, wherein the degree of conditioning may be controlled by controlling gauge pressure of the water providing said droplets in step (a).

24. A method for conditioning an indoor space as claimed in claim 21, further comprising the step (f) of collecting the separated water in step (e) and recirculating the water for use in step (a).

25. A method for conditioning an indoor space as claimed in claim 21, further comprising adding an additive to the said droplets in step (a).

26. A method for conditioning an indoor space as claimed in claim 25, wherein said additive comprises a suitable steriliser.

27. A method for conditioning an indoor space as claimed in claim 21, wherein said heat exchange between the said air flow and the said droplets in step (b) comprises providing the latent heat of evaporation to at least some of said droplets by said air flow.

28. A method for conditioning an indoor space as claimed in claim 21, wherein said air flow is induced in step (b) in a manner such as to increase the ambient pressure within said indoor space.

29. A method for conditioning an indoor space as claimed in claim 21, wherein said air flow is induced in step (b) in a manner such as to decrease the ambient pressure within said indoor space.

30. A method for conditioning an indoor space as claimed in claim 21, further comprising the step of filtering the air-water mixture remaining from step (d) prior to step (e).

31. A method for conditioning an indoor space as claimed in claim 30, wherein filtering step substantially prevents entry therethrough of foreign matter including insects and dust.

32. A method for conditioning an indoor space as claimed in any one of claims 21 to 31, wherein the flow area in step (c) is increased by between about 300% and 800% and preferably by about 600%.

33. A method as claimed in claim 32, wherein said indoor space comprises an indoor space of a greenhouse.
